(19) United States
(12) Patent Application Publication
(10) Pub. No.: US 2026/0122815 A1
(43) Pub. Date: Apr. 30, 2026

(54) MULTI-PURPOSE APPLICATION CHASSIS AND METHOD

(71) Applicant: Rockwell Collins, Inc., Cedar Rapids, IA (US)

(72) Inventors: Alan D. AMIS, Plano, TX (US); Raymond E. KNOFF, Vinton, IA (US); Nathan M. DUNSON, McKinney, TX (US); Martin J. JENNINGS, Oxford, IA (US)

(73) Assignee: Rockwell Collins, Inc., Cedar Rapids, IA (US)

(21) Appl. No.: 18/931,980

(22) Filed: Oct. 30, 2024

(51) Int. Cl. H05K 7/14; G06F 1/18

(52) U.S. Cl. CPC H05K 7/14; G06F 1/181

(57) ABSTRACT

A multi-purpose application chassis may provide multiple mission services and includes a chassis housing having a front-mounted display interface, one or more rear-mounted input/output (I/O) connectors, a first front-mounted slot configured for a removable encryptor module, and a second front-mounted slot configured for a removable baseboard module. The removable baseboard module includes a first programmable logic to provide zero root of trust, second programmable logic for I/O and network processing, a chip scale atomic clock (CSAC) configured as a master time source, a plurality of storage drives for network attached storage (NAS), and a plurality of transceivers to provide I/O between the I/O connectors and the first and second programmable logic. The first slot and storage drives are configured to handle COTS SATA encryption modules as well as PCIe encryption modules, and when installed can provide Data-at Rest (DAR) NAS.

### FIELD OF THE INVENTION

The subject matter disclosed herein relates to mission systems and, in particular, to a multi-purpose application chassis and method.

### BACKGROUND OF THE INVENTION

Historically, mission services such as Data-At-Rest (DAR), anti-tamper root of trust, input/output (I/O) and networking processors, computing resources, and master time services have been provided by discrete components and devices that make up the mission system solution. However, such mission system solutions using discrete components tend to increase the size, weight, power, and cost, which may be unacceptable for certain mission platforms.

The above information disclosed in this Background section is only for understanding of the background of the inventive concepts and, therefore, it may contain information that does not constitute prior art.

### SUMMARY OF THE INVENTION

The present disclosure is directed, in a first aspect, to a multi-purpose application chassis (MPAC). The MPAC includes a chassis housing having: a front-mounted display; one or more rear-mounted input/output (I/O) connectors; a first front-mounted slot configured for a removable encryptor module; and a second front-mounted slot configured for a removable baseboard module. The removable baseboard module includes: a first programmable logic configured to provide zero root of trust; a second programmable logic configured for I/O and network processing; a chip scale atomic clock (CSAC) connected to the first and/or the second programmable logic and configured as a master time source; a plurality of storage drives configured for network attached storage (NAS); and a plurality of transceivers configured to provide I/O between the I/O connectors and the first and second programmable logic.

In an embodiment of the MPAC, the first and second programmable logic may include a plurality of processor cores configured for providing processing.

In another embodiment of the MPAC, when an encryptor module is mounted in the first front-mounted slot, the plurality of storage drives may be configured to be connected to the encryptor module to provide a Data-At-Rest (DAR) NAS.

In a further embodiment of the MPAC, the plurality of storage drives may be M.2 drives with B+M key interfaces.

In yet another embodiment of the MPAC, the removable baseboard module may further include a switch configured to provide either peripheral component interconnect express (PCIe) data or serial advanced technology attachment (SATA) data between the encryptor module and the M.2 drives.

In an embodiment of the MPAC, the switch may include a first and second peripheral component interconnect express (PCIe) switch System-on-Module (SOM).

In another embodiment of the MPAC, the front-mounted display may include a touchscreen.

In a further embodiment of the MPAC, the rear-mounted input/output (I/O) connectors may include a 16-1 Gbps & ×8 PCIe optical connector, a 16-10 Gbps & ×8 PCIe optical connector, and a 16-1 Gbps copper connector.

In yet another embodiment, the MPAC may further include an I/O expansion connector having an RS-422, an RS-485, and/or an RS-232 interface.

In an embodiment of the MPAC, the plurality of transceivers may be a Universal Asynchronous Receiver-Transmitter (UART) RS-422, RS-485, and/or RS-232 transceiver.

In another embodiment of the MPAC, the first and second programmable logic may include a respective first and second multi-processor Field-Programmable Gate Array (FPGA).

The present disclosure is also directed, in a second aspect, to a removable baseboard module for a multi-purpose application chassis (MPAC) having a plurality of input/output (I/O) connectors, a first slot configured for a removable encryptor module, and a second slot configured for the removable baseboard module. The removable baseboard module includes: a first programmable logic configured to provide zero root of trust; a second programmable logic configured for I/O and network processing; a chip scale atomic clock (CSAC) connected to the first and/or the second programmable logic and configured as a master time source; a plurality of M.2 storage drives with B+M key interfaces configured to be connected to the removable encryptor module to provide a Data-At-Rest (DAR) network attached storage (NAS) when the removable encryption module is installed in the first slot; and a plurality of Universal Asynchronous Receiver-Transmitter (UART) transceivers configured to provide I/O between the I/O connectors and the first and second programmable logic.

In an embodiment of the baseboard module, the first programming logic may be disposed in a first multi-processor Field-Programable Gate Array (FPGA), the second programming logic may be disposed in a second multi-processor FPGA, and the first and second multi-processor FPGAs may include a plurality of processor cores configured for providing processing.

In another embodiment, the baseboard module may further include a switch configured to provide either peripheral component interconnect express (PCIe) data or serial advanced technology attachment (SATA) data between the removable encryptor module and the M.2 drives.

In a further embodiment of the baseboard module, the switch may include a first and second peripheral component interconnect express (PCIe) switch System-on-Module (SOM) connected in series.

The present disclosure is further directed, in a third aspect, to a method of providing mission services with a multi-purpose application chassis (MPAC). The method includes: inserting a removable encryption module into a first slot of the multi-purpose application chassis; inserting a removable baseboard module into a second slot of the multi-purpose application chassis, wherein the multi-purpose chassis provides interconnections between the removable encryption module and the removable baseboard module; providing a zero root of trust service via a first programable logic disposed on the removable baseboard module; receiving and transmitting data from an input/output (I/O) connector at an interface on the removable baseboard module; providing I/O and network processing services via a second programable logic disposed on the removable baseboard module; providing a master time service via a chip scale atomic clock (CSAC) disposed on the removable baseboard module and connected to the first programmable logic and/or the second programmable logic; and providing a Data-At-Rest (DAR) network attached storage (NAS) service via a plurality of M.2 storage drives with B+M key interfaces disposed on the removable baseboard module and connected to the removable encryptor module.

In an embodiment, the method may further include providing a user interface to the mission services via a touchscreen provided on the multi-purpose application chassis.

In another embodiment, the method may further include providing either peripheral component interconnect express (PCIe) data or serial advanced technology attachment (SATA) data between the removable encryptor module and the M.2 storage drives via a switch provided by a first PCIe switch System-on-Module (SOM) and a second PCIe switch SOM disposed on the removable baseboard module.

In a further embodiment, the method may also include providing processing services via a plurality of processor cores associated with the first and second programmable logic on the removable baseboard module.

In yet another embodiment, the method may further include removing the removable baseboard module to secure mission data on the plurality of M.2 storage drives.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1A is front view of a multi-purpose application chassis in accordance with the present disclosure;

FIG. 1B is front perspective view of a multi-purpose application chassis in accordance with the present disclosure;

FIG. 1C is side view of a multi-purpose application chassis in accordance with the present disclosure;

FIG. 1D is rear view of a multi-purpose application chassis in accordance with the present disclosure;

FIG. 1E is perspective view of a multi-purpose application chassis in accordance with the present disclosure;

FIG. 1F is perspective view of a multi-purpose application chassis with the modules being removed in accordance with the present disclosure; and

FIG. 2 is a schematic diagram of the modules in accordance with the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The present disclosure is directed to a multi-purpose application chassis (MPAC) that integrates the services of Data-At-Rest (DAR) network access storage (NAS), zero root of trust, I/O and network processor, computing resources, and a master time source into a single, small form factor (SFF) device.

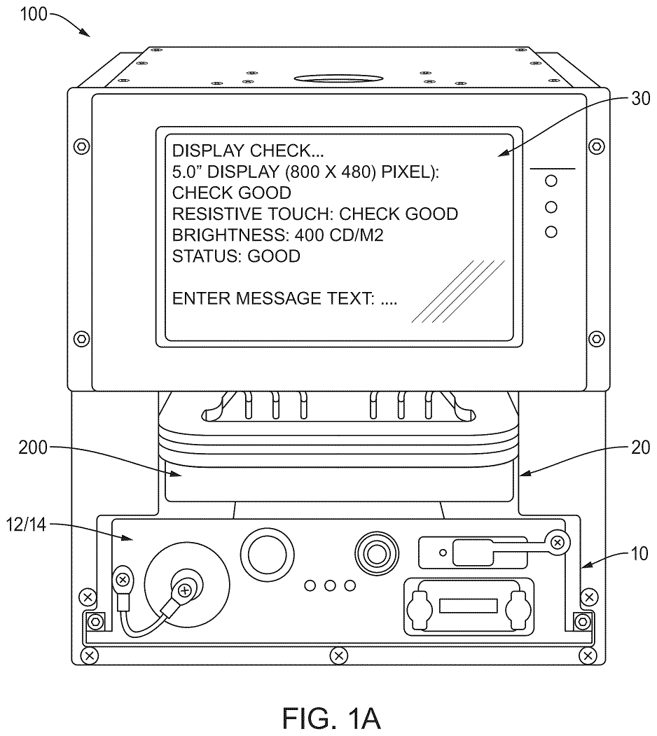

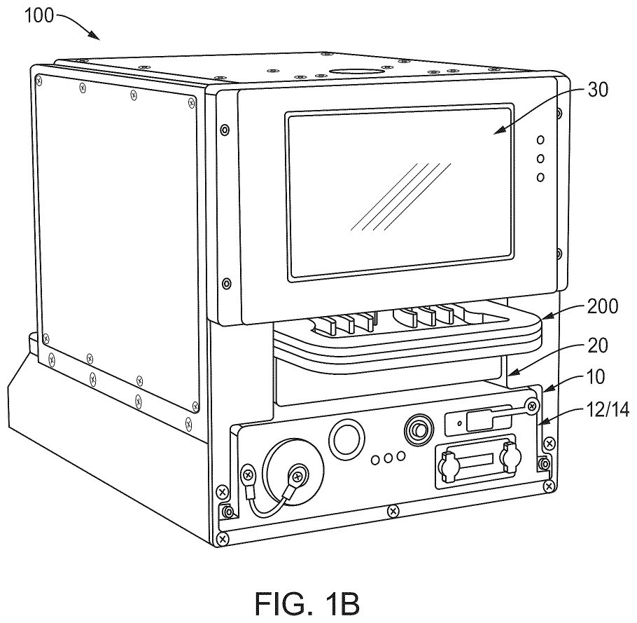

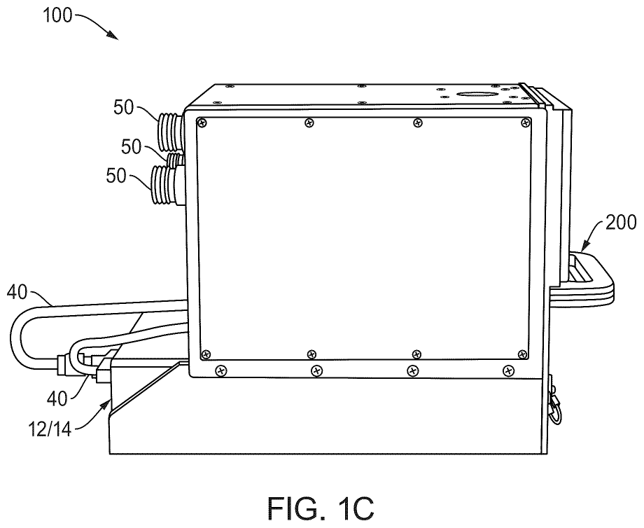

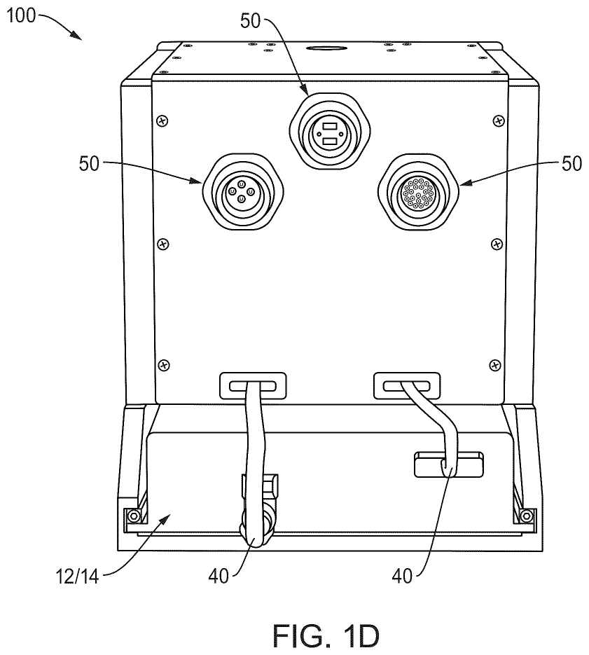

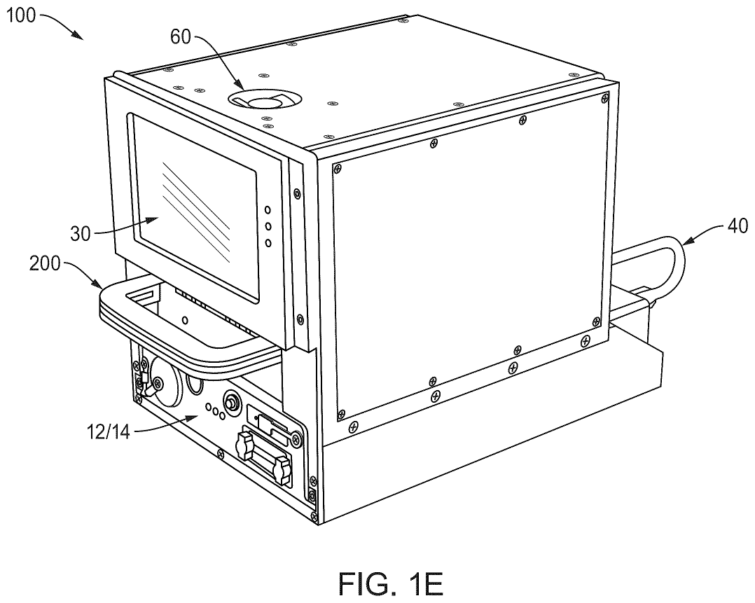

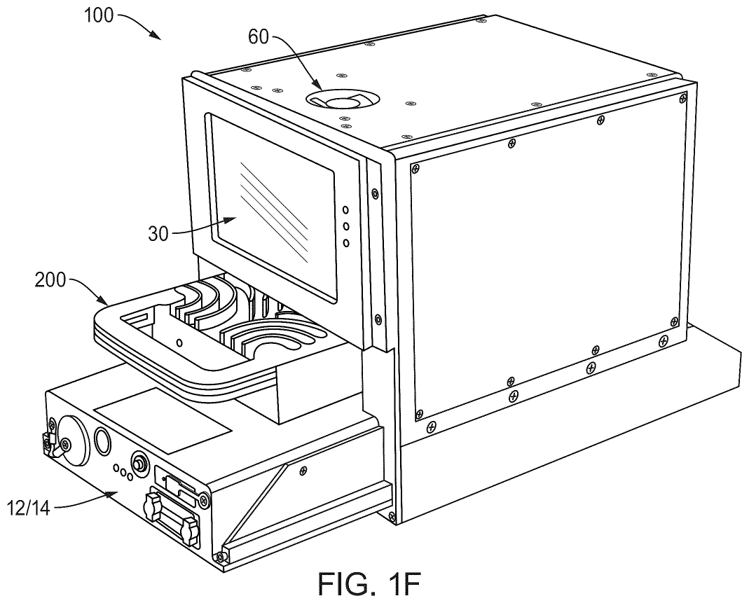

With reference to FIGS. 1A-1F, an embodiment of a multi-purpose application chassis (MPAC) 100 is disclosed. The MPAC 100 includes a chassis housing. The chassis housing may be dimensioned for a particular application or may be dimensioned to accommodate the required components in a compact package having a small form factor (SFF). The chassis housing may be made of any suitable material, such as aluminum or composites, and may include frame elements onto which panels have been secured via fasteners. In other embodiments, the chassis may be formed integrally and include one or more access panels to aid in assembly and servicing of components.

As illustrated most clearly in FIGS. 1E and 1F, the chassis housing of the MPAC 100 may include a ventilation port 60 with a fan for circulation of cooling air through the chassis housing.

The chassis housing of the MPAC 100 includes a front-mounted display 30, as illustrated in FIGS. 1A, 1B, 1E and 1F. The front-mounted display 30 may be a touchscreen interface formed of a flat panel LCD, OLED, AMOLED, or the like, and may be color or monochrome. In an embodiment, the front-mounted display 30 may be removable from the front for service or replacement, such as by removable fasteners or tabs.

The chassis housing of the MPAC 100 also includes one or more rear-mounted input/output (I/O) connectors 50, as illustrated in FIGS. 1C and 1D. Interfaces 50 may include connectors for RS-232, RS-422, RS-485 and the like (e.g., ARINC-429) and/or may provide, in one or more embodiments, a 16-1 Gbps & ×8 PCIe optical connector, a 16-10 Gbps & ×8 PCIe optical connector, and/or a 16-1 Gbps copper connector.

A front panel of the MPAC 100 includes a first front-mounted slot 10 configured for a removable encryptor module. For example, the removable encryptor module may be a commercial off the shelf (COTS) encryptor such as the General Dynamics KG-204 encryptor module, which receives data over one or more peripheral component interconnect express (PCIe) interfaces and outputs data over one or more serial advanced technology attachment (SATA) interfaces. In another example, the removable encryptor module may be a COTS encryptor such as the Collins IRAD Achronix encryptor module, which receives data over one or more PCIe interfaces and outputs data over one or more PCIe interfaces.

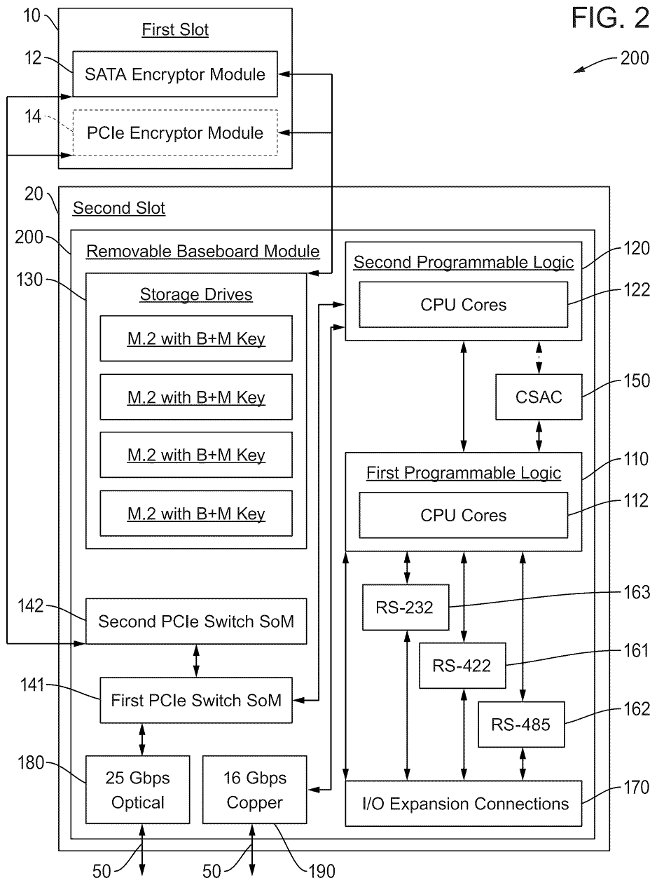

The front panel of the MPAC 100 also includes a second front-mounted slot 20 configured for a removable baseboard module 200. Additional details of the removable baseboard module 200 are disclosed in FIG. 2.

Regarding FIG. 2, the removable baseboard module 200 includes a first programmable logic 110 configured to provide zero root of trust. For example, the first programmable logic 110 may be a multi-processor field programmable gate array (FPGA) such as a ZU15EG Zynq UltraScale+ MPSoC or AMD Versal processor available from AMD/Xilinx and may be programmed to challenge and verify every device and detect any intrusions into the system to provide zero root of trust, such as by use of the Night Cover security suite components from Collins Aerospace.

The removable baseboard module 200 also includes a second programmable logic 120 configured for input/output (I/O) and network processing. For example, the second programmable logic 120 may be a multi-processor FPGA such as a ZU19EG Zynq UltraScale+ MPSoC or AMD Versal processor available from AMD/Xilinx and may be programmed to receive and transmit I/O data from I/O expansions connections 170 via universal asynchronous receivers/transmitters (UARTs) such as an RS-422 transceiver 161 for RS-422 serial interfaces, RS-485 transceiver 162 for RS-485 serial interfaces, and RS-232 transceiver 163 for RS-232 interfaces.

The second programmable logic 120 may also be programmed to receive and transmit network data, such as from the connectors 50 that include a 16-1 Gbps & ×8 PCIe optical connector, a 16-10 Gbps & ×8 PCIe optical connector, and/or a 16-1 Gbps copper connector. The optical connectors may be connected to a 12-channel duplex optical transceiver such as a LEAP OBT 12-TRX from Amphenol Active Optics Products and then connected to a META DX-2+ Ethernet PHY from Microchip Technology for input to/output from the second programmable logic 120. The copper connector may be connected to a META DX-2+ Ethernet PHY from Microchip Technology for input to/output from the second programmable logic 120. Such connections may provide 25 Gbps ×2 lanes (GTY) throughput.

The removable baseboard module 200 further includes a chip scale atomic clock (CSAC) 150 connected to the first programmable logic 110 and/or the second programmable logic 120. The CSAC 150 may be, for example, a CSAC-SA65 chip from Microchip Technology. The CSAC 150 is configured as a master time source. For example, the CSAC 150 may provide a 1 pulse-per-second (pps) output and a 10 MHz output to the first programmable logic 110, which can then provide 1 pps and 10 MHz outputs, such as to I/O expansion connections 170, as well as time of day (TOD).

A plurality of storage drives 130 are provided on the removable baseboard module 200 and are configured for network attached storage (NAS). In an embodiment, when an encryptor module 12 or 14 is mounted in the first front-mounted slot 10, the plurality of storage drives 130 may be configured to be connected to the encryptor module to provide a Data-At-Rest (DAR) NAS.

In one or more embodiments of the present disclosure, the plurality of storage drives 130 includes bilingual M.2 drives with B+M key interfaces. The removable baseboard module 200 may further include a switch configured to provide either PCIe data or SATA data between the encryptor module 12 or 14 and the M.2 drives 130. Thus, when an encryptor module 12 with a SATA output is used, the switch can send output to connectors in the first front-mounted slot 10 for encryptor module 12. When an encryptor module 14 with a PCIe output is used, the switch can send output to connectors in the first front-mounted slot 10 for encryptor module 14. The SATA data of encryptor module 12 and the PCIe data of encryptor module 14 can them be sent to the appropriate interface of the B+M keyed M.2 drives 130, with the B key slot used for SATA data and the M key slot for PCIe/NVMe data.

The switch may include a first PCIe switch System-on-Module (SOM) 141 and a second PCIe switch SOM 142 which can determine or detect which type of removable encryptor module 12 or 14 is installed in the first front-mounted slot 10. In one or more embodiments, the switch may be configured by the second programmed logic 120 or by one of the various network connections. The first PCIe switch SOM 141 may be used to switch between (external) data from fiber optic connectors 180 and data from the second programmable logic 110, and the second PCIe switch SOM 142 may be used to switch between a data connection with a SATA encryptor module 12 and a data connection with a PCIe encryptor 14.

The baseboard module 200 may include a plurality of transceivers configured to provide I/O between the I/O connectors 50 and 170 and the first and second programmable logic 110 and 120. Such transceivers may include the previously-described RS-422 transceiver 161, RS-485 transceiver 162, RS-232 transceiver 163, a 12-channel duplex optical transceiver such as a LEAP OBT 12-TRX from Amphenol Active Optics Products of element 180, and META DX-2+ Ethernet PHY from Microchip Technology of elements 180 and 190.

In one or more embodiments, the first programmable logic 110 and second programmable logic 120 may include a plurality of processor cores 112 and/or 122, respectively, that are configured for providing general processing functionality to the MPAC 100.

In one or more embodiments, the present disclosure is drawn to a removable baseboard module 200 for a multi-purpose application chassis 100 having a plurality of input/output (I/O) connectors 50, a first slot 10 configured for a removable encryptor module 12 or 14, and a second slot 20 configured for the removable baseboard module 200.

In various embodiments, the removable baseboard module 200 includes a first programmable logic 110 configured to provide zero root of trust, a second programmable logic 120 configured for I/O and network processing, a chip scale atomic clock (CSAC) 150 connected to the first programmable logic 110 and/or the second programmable logic 120 and configured as a master time source, a plurality of M.2 storage drives 130 with B+M key interfaces configured to be connected to the removable encryptor module 12 or 14 to provide a Data-At-Rest (DAR) network attached storage (NAS) when the removable encryption module 12 or 14 is installed in the first slot, and a plurality of Universal Asynchronous Receiver-Transmitter (UART) transceivers 161, 162, 163 configured to provide I/O between the I/O connectors and the first and second programmable logic.

In one or more embodiment of the removable baseboard module 200, the first programming logic 110 may be disposed in a first multi-processor Field-Programable Gate Array (FPGA), the second programming logic 120 may be disposed in a second multi-processor FPGA, and the first and second multi-processor FPGAs may include a plurality of processor cores configured for providing processing.

In an embodiment, the removable baseboard module 200 may further include a switch configured to provide either PCIe data or SATA data between the removable encryptor module 12 or 14 and the M.2 drives 130. In one or more embodiments, the switch may include a first and a second PCIe switch SOM connected in series.

In one or more embodiments, the present disclosure is drawn to a method of providing mission services with a multi-purpose application chassis 100. The method includes inserting a removable encryption module 12 or 14 into a first slot 10 of the multi-purpose application chassis 100 and inserting a removable baseboard module 200 into a second slot 20 of the multi-purpose application chassis 100, wherein the multi-purpose chassis 100 provides interconnections between the removable encryption module and the removable baseboard module. The interconnections may be provided by connectors (not shown) within the slots 10 and 20, a backplane (not shown) and/or via connection cables 40 (see FIGS. 1C, 1D, and 1E) disposed within and/or extending from the multi-purpose application chassis 100.

The method further includes providing a zero root of trust service via a first programable logic 110 disposed on the removable baseboard module 200, receiving and transmitting data from an input/output (I/O) connector 50 at an interface on the removable baseboard module 200, providing I/O and network processing services via a second programable logic 120 disposed on the removable baseboard module 200, providing a master time service via a chip scale atomic clock (CSAC) 150 disposed on the removable baseboard module 200 and connected to the first programmable logic 110 and/or the second programmable logic 120, and providing a Data-At-Rest (DAR) network attached storage (NAS) service via a plurality of M.2 storage drives 130 with B+M key interfaces disposed on the removable baseboard module 200 and connected to the removable encryptor module 12 or 14.

Embodiments of the method may further include providing a user interface to the mission services via a touchscreen 30 provided on the multi-purpose application chassis 100.

Embodiments of the method may also include providing either PCIe data or SATA data between the removable encryptor module 12 or 14 and the M.2 storage drives 130 via a switch provided by a first PCIe switch SOM 141 and a second PCIe switch SOM 142 disposed on the removable baseboard module 200.

The method may additionally include providing processing services via a plurality of processor cores 112 and 122 associated with the first and second programmable logic 110 and 120 on the removable baseboard module 200.

The method may also include removing the removable baseboard module 200 from the multi-purpose application chassis 100 to secure mission data on the plurality of M.2 storage drives 130.

In preparation for deployment on a mission, the MPAC 100 may be equipped with an NSA Type 1 Data-at-Rest (DAR) storage that encrypts the data stored on the drives 130. During an off-line ground process, the MPAC 100 may be loaded with all the boot images or infrastructure as code (IAC) required to bring up the system.

During deployment on the mission, the DAR storage is accessible to the computing servers via the network connectivity. Once deployed into the platform, the MPAC 100 acts as a Network Attached Server (NAS) allowing the servers to load and boot the IAC and bring the system up. During the mission, the servers will write log data, alerts, warning, etc. to the encrypted drives 130 which can be removed with the removable baseboard module for post mission analysis.

The use of bilingual M.2 B+M storage drives 130 that can handle PCIe data allows the platform to boot off of the drives with PCIe or to boot using external PCIe fiber off of the network. M.2 B+M storage drives 130 and the PCIe switch SoMs 141 and 142 also permit upgrading from SATA-based encryptor modules 12 to new PCIe-based encryptor modules 14, so as to “future proof” the MPAC 100.

The MPAC 100 also provides a platform suitable for serving as a data in transit cover for encryption devices. Encryption devices have plain text and cypher text interfaces. Cypher text can be transmitted in the clear as it is encrypted. The plain text, however, must be protected while in transit to the encryption device. Plain text can be covered by MACSec encryption by the source of the data and transmitted to the MPAC 100. The MACSec covered plain text is MACSec decrypted, and the plain text data is encrypted by the encryptor 12 or 14 and sent to the destination.

While the MPAC 100 provides mission functionality in the form of NAS, DAR, Zero Root-of-Trust, master time, general processing, data in transit cover, I/O, and network processing services, not all services need to be used, and in certain embodiments, only a subset of the services may be provided by MPAC 100 during a mission.

Additional elements, such as USB ports for keyboard and mouse input, may also be provided without departing from the scope of the invention.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A multi-purpose application chassis, comprising:
a chassis housing having:
a front-mounted display;
one or more rear-mounted input/output (I/O) connectors;
a first front-mounted slot configured for a removable encryptor module; and
a second front-mounted slot configured for a removable baseboard module; and
the removable baseboard module having:
first programmable logic configured to provide zero root of trust;
second programmable logic configured for I/O and network processing;
a chip scale atomic clock (CSAC) connected to the first and/or the second programmable logic and configured as a master time source;
a plurality of storage drives configured for network attached storage (NAS); and
a plurality of transceivers configured to provide I/O between the I/O connectors and the first and second programmable logic.

2. The multi-purpose application chassis of claim 1, wherein the first and second programmable logic comprise a plurality of processor cores configured for providing processing.

3. The multi-purpose application chassis of claim 1, wherein, when an encryptor module is mounted in the first front-mounted slot, the plurality of storage drives is configured to be connected to the encryptor module to provide a Data-At-Rest (DAR) NAS.

4. The multi-purpose application chassis of claim 3, wherein the plurality of storage drives is M.2 drives with B+M key interfaces.

5. The multi-purpose application chassis of claim 4, wherein the removable baseboard module further comprises a switch configured to provide either peripheral component interconnect express (PCIe) data or serial advanced technology attachment (SATA) data between the encryptor module and the M.2 drives.

6. The multi-purpose application chassis of claim 5, wherein the switch comprises a first and second peripheral component interconnect express (PCIe) switch System-on-Module (SOM).

7. The multi-purpose application chassis of claim 1, wherein the front-mounted display includes a touchscreen.

8. The multi-purpose application chassis of claim 1, wherein the rear-mounted input/output (I/O) connectors include a 16-1 Gbps & ×8 PCIe optical connector, a 16-10 Gbps & ×8 PCIe optical connector, and a 16-1 Gbps copper connector.

9. The multi-purpose application chassis of claim 1, further comprising an I/O expansion connector including an RS-422, an RS-485, and/or an RS-232 interface.

10. The multi-purpose application chassis of claim 1, wherein the plurality of transceivers is a Universal Asynchronous Receiver-Transmitter (UART) RS-422, RS-485, and/or RS-232 transceiver.

11. The multi-purpose application chassis of claim 1, wherein the first and second programmable logic comprise a respective first and second multi-processor Field-Programmable Gate Array (FPGA).

12. A removable baseboard module for a multi-purpose application chassis having a plurality of input/output (I/O) connectors, a first slot configured for a removable encryptor module, and a second slot configured for the removable baseboard module, the removable baseboard module comprising:
a first programmable logic configured to provide zero root of trust;
a second programmable logic configured for I/O and network processing;
a chip scale atomic clock (CSAC) connected to the first and/or the second programmable logic and configured as a master time source;
a plurality of M.2 storage drives with B+M key interfaces configured to be connected to the removable encryptor module to provide a Data-At-Rest (DAR) network attached storage (NAS) when the removable encryption module is installed in the first slot; and
a plurality of Universal Asynchronous Receiver-Transmitter (UART) transceivers configured to provide I/O between the I/O connectors and the first and second programmable logic.

13. The removable baseboard module of claim 12, wherein the first programming logic is disposed in a first multi-processor Field-Programable Gate Array (FPGA), the second programming logic is disposed in a second multi-processor FPGA, and the first and second multi-processor FPGAs comprise a plurality of processor cores configured for providing processing.

14. The removable baseboard module of claim 12, further comprising a switch configured to provide either peripheral component interconnect express (PCIe) data or serial advanced technology attachment (SATA) data between the removable encryptor module and the M.2 drives.

15. The removable baseboard module of claim 14, wherein the switch comprises a first and second peripheral component interconnect express (PCIe) switch System-on-Module (SOM) connected in series.

16. A method of providing mission services with a multi-purpose application chassis, comprising:
inserting a removable encryption module into a first slot of the multi-purpose application chassis;
inserting a removable baseboard module into a second slot of the multi-purpose application chassis, wherein the multi-purpose chassis provides interconnections between the removable encryption module and the removable baseboard module;
providing a zero root of trust service via a first programable logic disposed on the removable baseboard module;
receiving and transmitting data from an input/output (I/O) connector at an interface on the removable baseboard module;
providing I/O and network processing services via a second programable logic disposed on the removable baseboard module;
providing a master time service via a chip scale atomic clock (CSAC) disposed on the removable baseboard module and connected to the first programmable logic and/or the second programmable logic; and
providing a Data-At-Rest (DAR) network attached storage (NAS) service via a plurality of M.2 storage drives with B+M key interfaces disposed on the removable baseboard module and connected to the removable encryptor module.

17. The method of claim 16, further comprising providing a user interface to the mission services via a touchscreen provided on the multi-purpose application chassis.

18. The method of claim 16, further comprising providing either peripheral component interconnect express (PCIe) data or serial advanced technology attachment (SATA) data between the removable encryptor module and the M.2 storage drives via a switch provided by a first PCIe switch System-on-Module (SOM) and a second PCIe switch SOM disposed on the removable baseboard module.

19. The method of claim 16, further comprising providing processing services via a plurality of processor cores associated with the first and second programmable logic on the removable baseboard module.

20. The method of claim 16, further comprising removing the removable baseboard module to secure mission data on the plurality of M.2 storage drives.
